(19) United States
(12) Patent Application Publication
(10) Pub. No.: US 2010/0045185 A1
(43) Pub. Date: Feb. 25, 2010

(54) CATHODE FOR DISCHARGE LAMP AND DISCHARGE LAMP USING THE SAME

(75) Inventors: Tetsuya Kitagawa, Hyogo (JP); Shunichi Morimoto, Hyogo (JP); Tomoyoshi Arimoto, Hyogo (JP); Mitsuru Ikeuchi, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: Ushio Inc., Tokyo (JP)

(21) Appl. No.: 12/544,601

(22) Filed: Aug. 20, 2009

(30) Foreign Application Priority Data
Aug. 20, 2008 (JP) 2008-211264

(51) Int. Cl. H01J 61/04; H01J 1/00

(52) U.S. Cl. 313/632; 313/310

(57) ABSTRACT

A cathode for a discharge lamp contains emitter material, wherein a carbide layer is formed on an outer surface of the cathode, the carbide layer is formed on an area extending from a tip portion of the cathode, and two or more grooves extending toward the tip portion of the cathode are formed on the area where the carbide layer is formed.

### CROSS-REFERENCES TO RELATED APPLICATION

This application claims priority from Japanese Patent Application Serial No. 2008-211264 filed Aug. 20, 2008, the contents of which are incorporated herein by reference in its entirety.

### TECHNICAL FIELD

The present invention generally relates to a cathode for a discharge lamp, and a discharge lamp having the cathode containing an emitter material, wherein a carbide layer is formed on an outer surface thereof.

### BACKGROUND

A xenon lamp or discharge lamp, such as a short arc type high-pressure mercury lamp, is used as a light source of, for example, a projector, a semiconductor exposure apparatus, a liquid crystal exposure apparatus or a printed circuit board exposure apparatus, which uses the DLP® (Digital Light Processing) technology. Such a discharge lamp is turned on by direct-current power source, and electrons are emitted toward an anode from a cathode during lighting. The electrode of such a discharge lamp is made of high melting point metal, such as tungsten, and specifically the cathode contains an emitter material which consists of a metal oxide, such as thorium oxide, in order to stably emit electrons from the cathode. In the cathode heated by lighting of a discharge lamp, metal atoms are taken out from the metal oxide which forms the emitter material, by reduction action caused by the tungsten which forms the cathode, so that the metal atoms act as an emitter. Moreover, in order to take out the metal atoms at high efficiency from the metal oxide which forms the emitter material and to stably supply them to the tip of the cathode from which electrons are emitted, it is known to form a carbide layer which consists of, for example, tungsten carbide, on an outer surface of an area extending from the tip portion of the cathode, by carrying out carbonization processing of the outer surface thereof (refer to Patent Publication No. H05-86026 and Patent Application Publication No. 2000-21349).

In addition, there is a demand for much more brightness in a discharge lamp in recent years. As a possible means for obtaining high brightness in such a discharge lamp, shortening of a distance between the electrodes may be considered. However, in such a discharge lamp, when high electrical current flows between the electrodes during lighting, the cathode is heated to very high temperature so that the emitter material contained in the cathode evaporates thereby decreasing or being depleted at an early stage. As a result, electrons are not stably emitted from the cathode, so that there is a problem that flickering of the radiation light, that is, a flicker occurs at an early stage.

### SUMMARY

In view of the above background, described herein is a cathode for a discharge lamp and a discharge lamp having such a cathode which is capable of emitting light stably for a long time without flickering of radiation light at an early stage

The present cathode for a discharge lamp contains emitter material, wherein a carbide layer is formed on an outer surface of the cathode, the carbide layer is formed on an area extending from a tip portion of the cathode, and two or more grooves extending toward the tip portion of the cathode are formed the area where the carbide layer is formed.

In the present cathode for a discharge lamp, the two or more grooves may be formed so as to be apart from each other. Moreover, it is desirable that the thickness of the carbide layer may be smaller than the depth of the groove.

Another aspect of the present invention is that the present discharge lamp has the above-mentioned cathode for discharge lamp.

In the present cathode for a discharge lamp, since evaporation of the emitter material is suppressed by forming the two or more grooves extending toward the tip of the cathode for a discharge lamp on the area in which the carbide layer is formed, the emitter material does not decrease or is not depleted at an early stage, so that flickering of a radiation light does not occur at such an early stage, whereby it is possible to realize a discharge lamp capable of stably emitting light for a long time. Moreover, since loss of the carbide layer is prevented or suppressed by the two or more grooves which are arranged apart from one another, the shape of these grooves is maintained so that the evaporation of the emitter material is suppressed certainly, whereby it is possible to stably emit electrons over a long time. Moreover, since loss of the carbide layer formed in portions other than a groove (top part) is suppressed by forming the carbide layer of thickness smaller than the depth of these grooves, the shape of grooves is maintained and the evaporation of the emitter material is controlled certainly, whereby it is possible to stably emit electrons over a long time.

### BRIEF DESCRIPTION OF DRAWINGS

Other features and advantages of the present cathode for a discharge lamp and the present discharge lamp using the cathode will be apparent from the ensuing description, taken in conjunction with the accompanying drawings, in which:

FIG. 1 is a diagram showing the structure of a cathode for a discharge lamps according to an embodiment;

FIG. 2 is an explanatory diagram which is viewed from a tip side of a cathode for a discharge lamp shown in FIG. 1;

FIG. 3 is a cross sectional view of the cathode for a discharge lamps shown in FIG. 1, taken along a line 3-3 thereof;

FIG. 4 is an explanatory diagram showing the structure of another example of a cathode for a discharge lamp according to an embodiment;

FIG. 5 is an explanatory diagram which is viewed from a tip side of a cathode for the discharge lamps shown in FIG. 4;

FIG. 6 is an explanatory cross sectional view showing the structure of a discharge lamp according to an embodiment; and

FIG. 7 is an explanatory diagram showing a modified embodiment of a cathode for a discharge lamp according to an embodiment.

### DETAILED DESCRIPTION

A description will now be given, referring to embodiments of the present cathode for a discharge lamp and the present discharge lamp using the cathode. While the claims are not limited to such embodiments, an appreciation of various aspects of the present cathode for a discharge lamp and the present discharge lamp using the cathode is best gained through a discussion of various examples thereof.

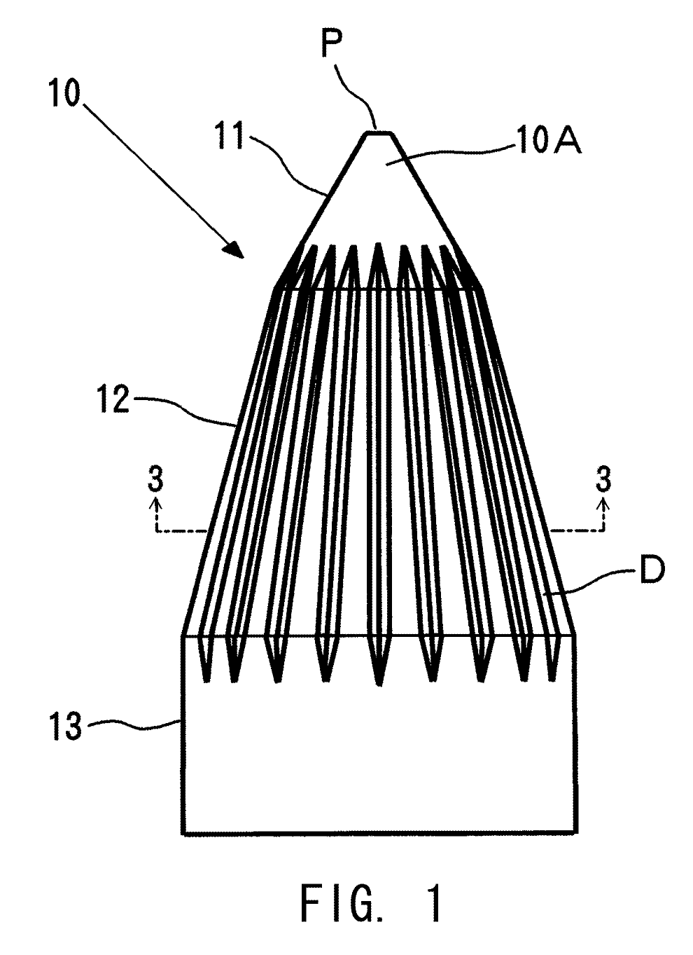

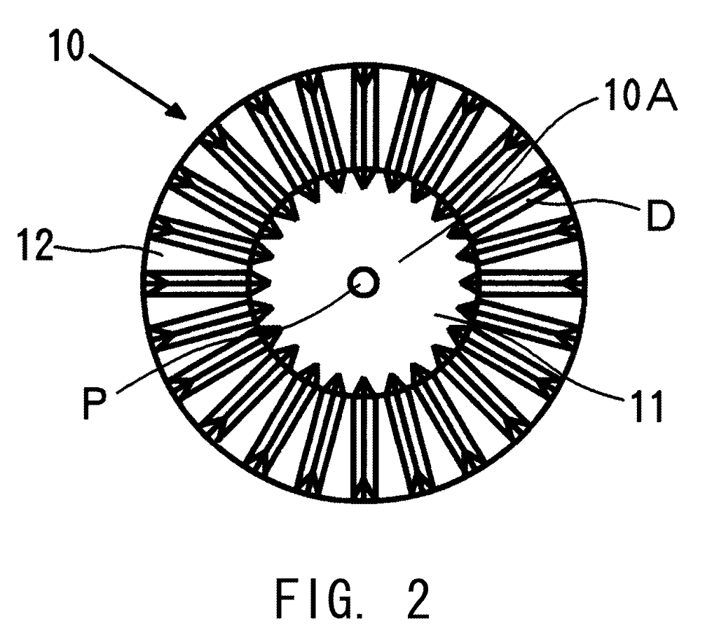

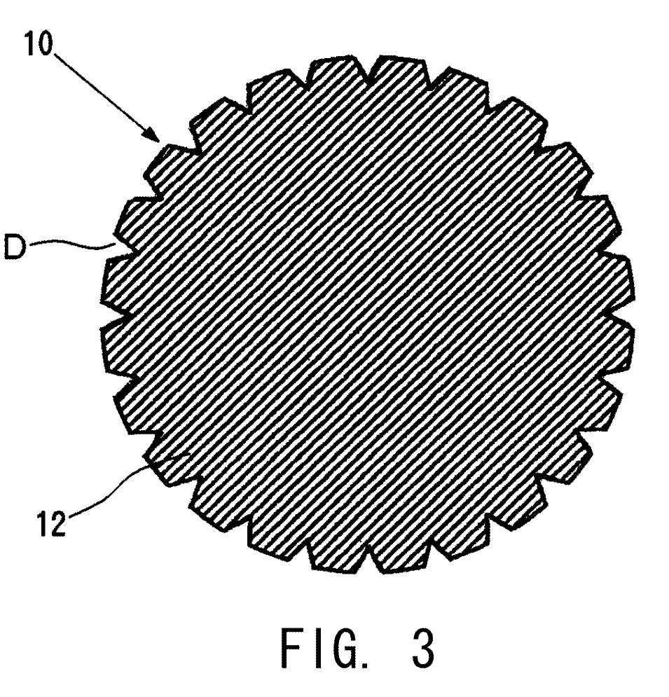

FIG. 1 is an explanatory diagram showing the structure of a cathode for a discharge lamp according to an embodiment. FIG. 2 is an explanatory diagram of the cathode for a discharge lamp shown in FIG. 1, which is viewed from a tip side thereof. FIG. 3 is a cross sectional view of the cathode for a discharge lamps shown in FIG. 1, taken along a line 3-3 of FIG. 1. An emitter material is contained (doped) in a base material of a cathode 10 for a discharge lamp (hereinafter merely referred to as “cathode”), which is a high melting point metal such as tungsten, and a carbide layer is formed on an outer surface of the cathode 10. Moreover, the cathode 10 has a flat face at a tip P thereof, a first taper portion 11 in a truncated cone shape whose diameter becomes smaller as closer to the tip P, a second taper portion 12 in a truncated cone shape whose diameter becomes smaller as closer to the first taper portion 11 and, which follows from and the first taper portion 11 and is integrally formed with the first taper portion 11, and a cylindrical body portion 13 which is integrally formed following the second taper portion 12. The inclination angle of an outer surface of the second taper portion 12 with respect to the central axis of the cathode 10 is smaller than that of the first taper portion 11. Thus, in case where such two step taper portions are formed and the grooves D are formed in the second taper portion 12 with a lathe, since it is not necessary to move the lathe or the cathode 10 upward or downward, but what is necessary is just to move the lathe relatively with respect to the second taper portion 12 along the slope thereof, the grooves D can be easily formed in the second taper portion 12, and further expansion and contraction of a luminescent spot can be suppressed during lighting of the discharge lamp. The carbide layer is formed on areas following the tip portion 10A of the cathode 10, that is, a base end portion of the first taper portion 11, and an area of the outer surface of the second taper portion 12. On the other hand, the carbide layer is not formed in the outer surface of the tip portion 10A of the cathode 10. Specifically, the two or more V-shaped grooves D linearly extending toward the tip P are formed apart from one another at equal intervals, on areas of the outer surface of the cathode 10 on which the carbide layer is formed, that is, areas which extend from the base end portion of the first taper portion 11, to a top side portion of a body portion 13 (a portion of the body portion 13 in a side of the second taper portion 12 through the second taper portion 12). It is desirable that the grooves are not formed on the tip portion 10A of the cathode 10, on which the carbide is not formed. When the grooves D are formed in the tip portion 10A of the cathode 10, arc is not stably formed so that there is a possibility of causing flickering of a radiation light.

The emitter material is contained in the basis material of the cathode 10 in form of an oxide of one kind or two or more kinds of metals, such as thorium oxide, barium oxide, lanthanum oxide or a compound oxide of lanthanum oxide and zirconium oxide. The number of the grooves D formed in the cathode 10 is 20-70. Moreover, the depth of each groove D is 60-500 μm (micrometers). Moreover, the length of the tip portion on which the carbide layer of the cathode 10 is not formed along the axis direction thereof, is 1-4 mm.

The carbide layer can be formed by carrying out a carbonization process on the outer surface of the basis material which forms the cathode 10. Metal atoms are more easily taken out from the metal oxide which forms the emitter material, as the thickness of this carbide layer is large, so that they are easily supplied to the tip portion of the cathode 10. However, it is desirable that the thickness of the carbide layer is smaller than that of the grooves D. That is, since the strength of the carbide such as tungsten carbide is lower than that of the high melting point metal, for example, tungsten, which is the basis material of the cathode 10, when the thickness of the carbide layer is larger than the depth of the grooves D, the carbide layer formed in portions other than the grooves D (the top part) tends to be lost. Moreover, the desirable thickness of the carbide layer is 30-100 μm (micrometers). Here, the thickness of the carbide layer can be measured by using an electron scanning microscope etc., after grinding a cutting plane of the cathode 10 and carrying out an etching process with etching liquid.

The following is the specification of an example, such as the size of each part of this cathode 10. The full length of the cathode 10 is 18 mm, the length of the first taper portion 11 in the axial direction in is 4 mm, the length of the second taper portion 12 in the axial direction is 9 mm, and the length of the body portion in the axial direction 13 is 5 mm. The diameter of the tip P is 0.6 mm, and that of the body portion 13 is 10 mm. The inclination angle of the outer surface of the first taper portion 11 with respect to the central axis of the cathode 10 is 60 degrees, and that of the outer surface of the second taper portion 12 with respect to the central axis of the cathode 10 is 30 degrees. Twenty four (24) grooves D whose width is 0.5 mm and whose depth is 0.4 mm are formed apart from one another at equal intervals in the circumferential direction (whose angles with respect to the central axis of the cathode 10 are 15 degrees). Moreover, the carbide layer is formed over areas between the position of 3 mm from the tip P and the base end of the second taper portion 12, and the thickness thereof is 30 μm (micrometers).

In such a cathode 10, evaporation of the emitter material is suppressed by forming two or more grooves D which extend from a top portion of the cylindrical body portion 13 toward the tip of the cathode 10 on the areas on which a carbide layer is formed. It is believed that since the grooves D are surrounded by the outer surface of the cathode 10 so that this surface area of the cathode 10 is large, the emitter material which is once evaporated is again trapped to the cathode 10, thereby being supplied to the tip portion of the cathode 10 along the grooves D. As a result, the emitter material in the cathode 10 does not decrease or is not depleted at an early stage. Therefore, it is possible to realize a discharge lamp in which light is emitted stably for a long time without flickering of a radiation light at an early stage. Moreover, since the two or more grooves D are formed so as to be apart from each other, formation of a pointed portion(s) on the outer surface of the cathode 10 is avoided. Therefore, since loss of the carbide layer is suppressed or prevented, the shape of the grooves D is maintained and evaporation of the emitter material is suppressed certainly, whereby it is possible to stably emit electrons for a long time. Moreover, since loss of the carbide layer formed in portions other than the grooves D (top part) is suppressed by forming the carbide layer of the thickness smaller than the depth of the grooves D, the shape of the grooves is maintained and evaporation of the emitter material is suppressed certainly, whereby it is possible to stably emit electrons over a long time.

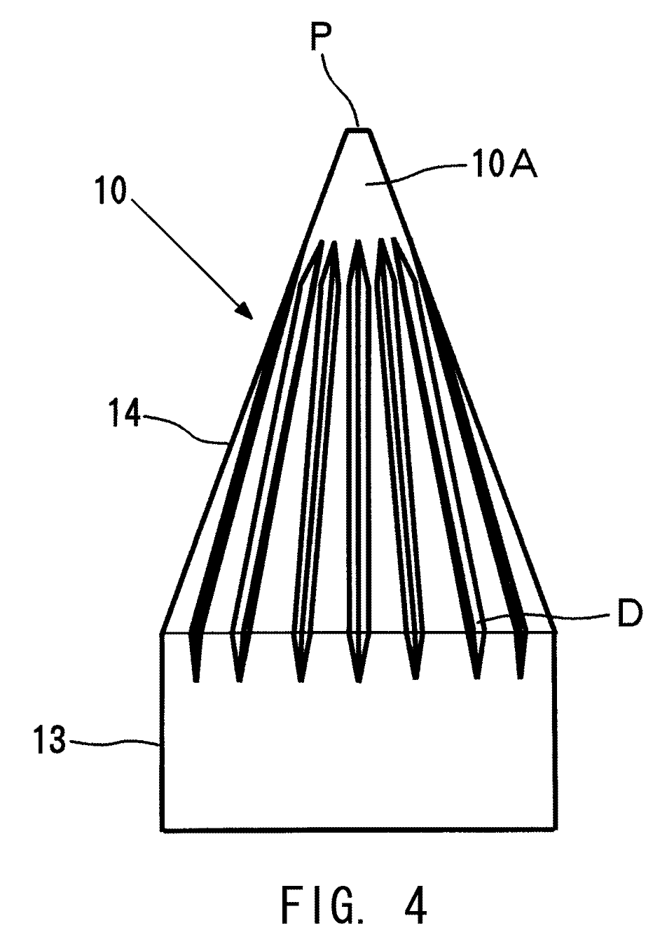

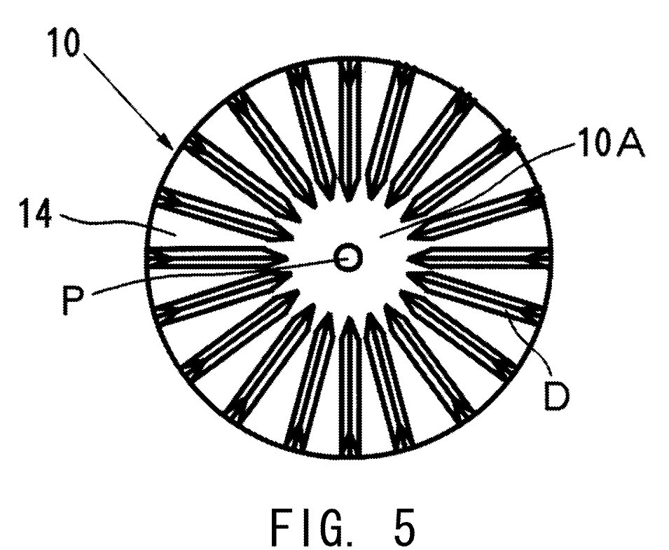

FIG. 4 is an explanatory diagram showing the structure of a cathode for a discharge lamp according to another embodiment. FIG. 5 is an explanatory diagram which is viewed from a tip side of the cathode a the discharge lamp shown in FIG. 4. The cathode 10 has a flat face at a tip P thereof, and further includes a taper portion 14 in a truncated cone shape whose diameter becomes smaller as closer to the tip P, and a cylindrical body portion 13 which is integrally formed with and follows the taper portion 14. The carbide layer (not shown) is formed on outer surface areas of the cathode, following the tip portion 10A of the cathode 10, that is, outer surface areas of a central portion and a base end portion of the taper portion 14. On the other hand, the carbide layer is not formed in the outer surface of the tip portion 10A of the cathode 10. The two or more V-shaped grooves D which linearly extending toward the tip P from the top side portion of the cylindrical body portion 13 are formed apart from each other (one another) at equal intervals, on areas of the outer surface of the cathode 10 in which the carbide layer is formed, that is, areas which extends from the central portion of the taper portion 14 to the top side portion of the body portion 13 (a portion of the cylindrical body portion 13 in a side of the taper portion 14). The other parts of structure are the same as those of the cathode 10 shown in FIG. 1.

The following is the specification of an example, such as the size of each part of this cathode 10. The full length of the cathode 10 is 18 mm, the length of the taper portion 14 in the axial direction is 13 mm, and the length of the body portion 13 in the axial direction is 5 mm. The diameter of the tip P is 0.6 mm, and the diameter of the body portion 13 is 10 mm. The inclination angle of the outer surface of the taper portion 14 with respect to the central axis of the cathode 10 is 40 degrees. Twenty (20) grooves D whose width is 0.5 mm and whose depth is 0.4 mm are formed apart from each other (one another) at equal intervals in the circumferential direction (whose angles with respect to the central axis of the cathode 10 are 18 degrees). Moreover, the carbide layer is formed over areas between the position of 3 mm from the tip P and the base end of the taper portion 14, and the thickness thereof is 30 μm (micrometers).

It is believed that in such a cathode 10, the emitter material in the cathode 10 does not decrease or is not depleted at an early stage, since evaporation of an emitter material is suppressed by forming two or more grooves D which extend toward the tip of the cathode 10 on the areas in which a carbide layer is formed. Therefore, it is possible to realize a discharge lamp in which light is emitted stably for a long time without flickering of a radiation light at an early stage. Therefore, since the two or more grooves D are formed so as to be apart from each other, so that loss of the carbide layer is suppressed or prevented, the shape of the grooves D is maintained and evaporation of the emitter material is suppressed certainly, whereby it is possible to stably emit electrons for a long time. Moreover, since loss of the carbide layer formed in portions other than the grooves D (top part) is suppressed by forming the carbide layer of the thickness smaller than the depth of the grooves D, the shape of the grooves is maintained and evaporation of the emitter material is suppressed certainly, whereby it is possible to stably emit electrons over a long time.

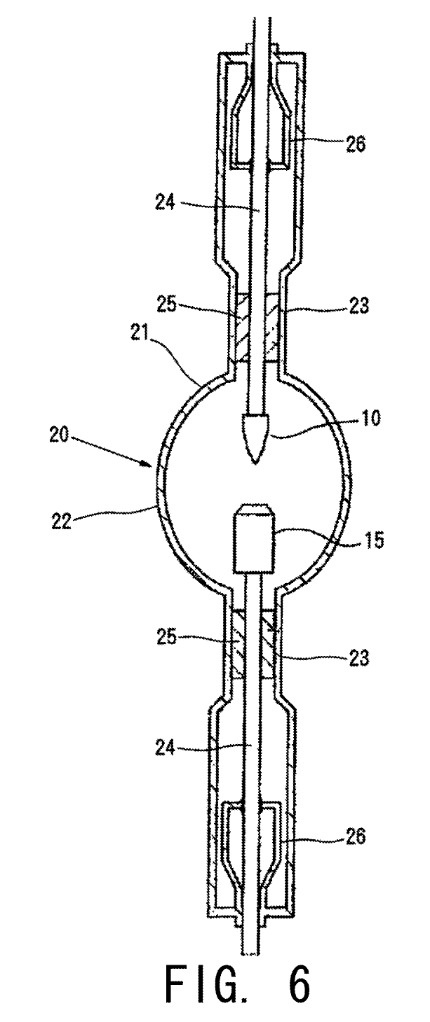

FIG. 6 is an explanatory cross sectional view showing the structure of a discharge lamp according to an embodiment. This discharge lamp 20 has an arc tube 21 which is made of, for example, quartz glass. The arc tube 21 has a light emission portion 22 which is an oval sphere in shape, and straight tube shaped sealing portions 23, each of which is formed at an end of the light emission portion 22. In the light emission portion 22 of the arc tube 21, the present cathode 10 and an anode 15 which is made of, for example, tungsten, are arranged along the direction of a tube axis so as to be apart from and face each other. Each of the cathode 10 and the anode 15 is supported by a lead rod 24. Each of these lead rods 24 extends from the inside of the light emitting portion 22 in the axis direction and is arranged so as to project in an outer direction, through the sealing portion 23 from an outer end portion of the sealing portion 23. In other words, the lead rods project into the light emitting portion 22 from the respective sealing portions 23 in the inward direction. In addition, these lead rods 24 are inserted in a cylindrical body for holding the lead rod 24 and held by the cylindrical body, and further are attached and sealed to the respective sealing portions 23 by a connecting member 26 formed in an outer end portion side of the sealing portion 23.

In such a discharge lamp 20, since the present cathode 10 is provided, flickering of a radiation light does not occur at an early stage, so that light can be stably emitted for a long time. Such a discharge lamp 20 can be suitably used as a light source of, for example, a projector, a semiconductor exposure apparatus, a liquid crystal exposure apparatus or a printed circuit board exposure apparatus, which use the DLP technology (DLP is a TRADEMARK).

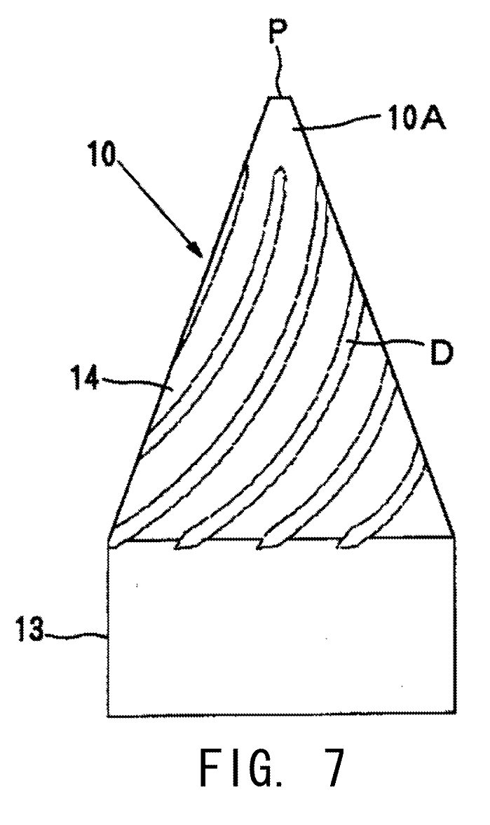

As mentioned above, although the embodiments according to the present invention are explained above, it is possible to make various changes. For example, the grooves D may not be limited to V-shaped grooves, and may be U-shaped grooves, or grooves in other shape. Moreover, the grooves D are not necessarily formed in the shape of a straight line, and, for example, as shown in FIG. 7, they may be formed so as to extend spirally toward the tip P of the cathode 10.

### Example

Although a concrete example will be described below. However, the present invention is not limited to this concrete example.

As in the structure shown in FIG. 1, the cathode was made from a base material in which thorium oxide was doped in tungsten. The full length of the cathode was 18 mm, the length of the first taper portion 11 in the axial direction was 4 mm, the length of the second taper portion 12 in the axial direction was 9 mm, and the length of the body portion 13 in the axial direction was 5 mm. The diameter of the tip P was 0.6 mm, and that of the body portion 13 was 10 mm. The inclination angle of the outer surface of the first taper portion 11 with respect to the central axis of the cathode 10 was 60 degrees, and that of the outer surface of the second taper portion 12 with respect to the central axis of the cathode 10 was 30 degrees. Twenty four (24) grooves D whose width was 0.5 mm and whose depth was 0.4 mm were formed apart from each other (one another) at equal intervals in the circumferential direction (whose angles with respect to the central axis of the cathode 10 were 15 degrees). In the above specification of the cathode 10, the carbide layer was formed over areas between the position of 3 mm from the tip P and the base end of the second taper portion 12, wherein the thickness thereof was 30 μm (micrometers). A discharge lamp (20) of the specification set forth below was produced based on the structure shown in FIG. 6, using the above described cathode 10. An arc tube was made of quartz glass, wherein the full length thereof was 250 mm. The length, the largest inner diameter, the largest outer diameter, and the volume of the light emitting portion 22 were respectively, 80 mm, 54 mm, 60 mm and 112 mm³. The outer diameter of the sealing portions 23 in an anode side was φ26 mm, and the inner diameter thereof was 21 mm. The outer diameter of a sealing portion 23 in a cathode side was φ22.5 mm, and the inner diameter thereof was 17.5 mm. The outer diameter and the inner diameter of the shrunk portions of the sealing portion 23 was φ16 mm and 11 mm, respectively. The anode 15 was made of tungsten, wherein the full length thereof was 31 mm, the diameter of the tip was 6 mm, the diameter of the body portion was 20 mm, and a distance between these electrodes was 4.5 mm. Each lead rod 24 was made of tungsten. The full length of the lead rod in an anode side was 114 mm, that in a cathode side was 96 mm, and the outer diameter of the lead rod was 6 mm. Xenon gas was enclosed in the discharge lamp.

After turning on the above-mentioned discharge lamp 20 with 4 kW electric power for 2 hours, the light of the discharge lamp was turned off for 30 minutes. When a cycle of lighting on and off was repeated, a flicker occurred after total light time of 630 hours. In addition, it was regarded that a flicker occurred when the voltage impressed to the discharge lamp 20 changed by 1.2 V or more.

### Comparative Example

Except the cathode having no grooves was used, a discharge lamp having the same specification as the above-mentioned concrete embodiment was produced. In this discharge lamp, after total light time of 480 hours, a flicker occurred like the above-mentioned concrete embodiment.

Thus, in the present cathode 10 according to the embodiments, it was confirmed that the discharge lamp 20 in which the flickering of a radiation light did not occur at an early stage, and light was emitted stably for a long time.

The preceding description has been presented only to illustrate and describe exemplary embodiments of the present cathode for a discharge lamp and the present discharge lamp using the cathode. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. A cathode for a discharge lamp, which contains emitter material, wherein a carbide layer is formed on an outer surface of the cathode, the carbide layer is formed on an area extending from a tip portion of the cathode, and two or more grooves extending toward the tip portion of the cathode are formed on the area where the carbide layer is formed.

2. The cathode according to claim 1, wherein the two or more grooves are formed apart from each other.

3. The cathode according to claim 1, wherein the two or more grooves are at equal intervals.

4. The cathode according to claim 1, wherein a thickness of the carbide layer is smaller than a depth of the grooves.

5. The cathode according to claim 1, wherein a thickness of the carbide layer is smaller than a depth of the grooves.

6. The cathode according to claim 1, wherein the grooves are formed so as to linearly extend toward the tip portion.

7. The cathode according to claim 1, wherein the grooves are formed so as to extend spirally toward the tip portion.

8. The cathode according to claim 1, including a first taper portion in a truncated cone shape, whose diameter becomes smaller as closer to the tip portion of the cathode, and a cylindrical body portion.

9. The cathode according to claim 1, further including a second taper portion in a truncated cone shape, whose diameter becomes smaller as closer to the first taper portion and, which follows from and the first taper portion and is integrally formed with the first taper portion.

10. The cathode according to claim 9, wherein an inclination angle of an outer surface of the second taper portion with respect to a central axis of the cathode is smaller than that of the first taper portion.

11. The cathode according to claim 1, wherein a base material of a cathode is a high melting point metal.

12. The cathode according to claim 11, wherein the high melting point metal is tungsten.

13. The cathode according to claim 1, wherein the emitter material is made of a metal oxide.

14. The cathode according to claim 13, wherein the metal oxide is thorium oxide, barium oxide, lanthanum oxide or a compound oxide of lanthanum oxide and zirconium oxide.

15. The cathode according to claim 1, wherein a number of the grooves formed in the cathode is 20-70.

16. The cathode according to claim 1, wherein a depth of the grooves is 60-500 μm.

17. The cathode according to claim 1 wherein the carbide layer is not formed on the tip portion of the cathode.

18. The cathode according to claim 1 wherein a length of the tip portion on which the carbide layer is not formed along an axis direction of the cathode, is 1-4 mm.

19. The cathode according to claim 1, wherein a thickness of the carbide layer is 30-100 μm.

20. A discharge lamp comprising the cathode according to claim 1.
